(19) United States
(12) Patent Application Publication
(10) Pub. No.: US 2026/0081062 A1
(43) Pub. Date: Mar. 19, 2026

(54) COIL COMPONENT

(71) Applicant: Murata Manufacturing Co., Ltd., Kyoto-fu (JP)

(72) Inventors: Masayoshi NAKAMURA, Nagaokakyo-shi (JP); Shinya HIRAI, Nagaokakyo-shi (JP)

(73) Assignee: Murata Manufacturing Co., Ltd., Kyoto-fu (JP)

(21) Appl. No.: 19/250,974

(22) Filed: Jun. 26, 2025

(30) Foreign Application Priority Data
Sep. 18, 2024 (JP) 2024-161109

(51) Int. Cl. H01F 27/26; H01F 27/02

(52) U.S. Cl. CPC H01F 27/266; H01F 27/02

(57) ABSTRACT

A coil component includes a core, made of a magnetic material, that includes a winding core portion and first and second flange portions that are at ends of the winding core portion that are opposite to each other in an axial direction, a top plate, made of a magnetic material, that extends between the first and second flange portions, and at least one wire wound around the winding core portion. The top plate is fixed to the core in a state in which the top plate faces top surfaces of the first and second flange portions and a gap having an average dimension of from 20 μm to 50 μm is between the top plate and the top surfaces, and the ratio of the cross-sectional area of the top plate to the cross-sectional area of the winding core portion is from 0.478 to 0.956 as viewed along a surface.

### CROSS-REFERENCE TO RELATED APPLICATION

This application claims benefit of priority to Japanese Patent Application No. 2024-161109, filed Sep. 18, 2024, the entire content of which is incorporated herein by reference.

### BACKGROUND

### Technical Field

The present disclosure relates to a coil component that includes a core including a winding core portion around which a wire is wound and first and second flange portions that are provided at end portions of the winding core portion, and a top plate that extends between the first and second flange portions.

### Background Art

As a technique relating to the present disclosure, for example, Japanese Unexamined Patent Application Publication No. 2018-107248 describes a coil component that includes a core that includes a winding core portion around which a wire is wound and first and second flange portions that are provided at end portions of the winding core portion, and a top plate that extends between the first and second flange portions. In the coil component described in Japanese Unexamined Patent Application Publication No. 2018-107248, the top plate is fixed to the core with a gap provided between the top plate and the first and second flange portions to obtain good DC superposition characteristics. The gap is formed by, for example, small projections being provided at portions of the top plate that face the flange portions. By the gap being provided as described above, magnetic saturation is suppressed from occurring in a closed magnetic circuit structure formed by the core and the top plate, and the DC superposition characteristics of the coil component can be improved.

### SUMMARY

The larger the gap described above, the higher the effect of magnetic saturation suppression. However, when the gap is too large, the effect of increased inductance due to the presence of the top plate can hardly be expected. In addition, even when the gap is provided, if the cross-sectional ratio between the core and the top plate that form a closed magnetic circuit is inappropriate, since one of them preferentially undergoes magnetic saturation, DC superposition characteristics degrade. Accordingly, there are limitations to improvement of DC superposition characteristics only by providing the gap.

Accordingly, the present disclosure provides a coil component that has improved DC superposition characteristics without relying only on the gap.

The present disclosure is applied to a coil component including a core, made of a magnetic material, that includes a winding core portion that extends in an axial direction, and a first flange portion and a second flange portion that are provided at a first end and a second end, respectively, of the winding core portion, the first end and the second end being provided opposite to each other in the axial direction; a top plate, made of a magnetic material, that extends between the first flange portion and the second flange portion; and at least one wire wound around the winding core portion.

The first flange portion and the second flange portion have bottom surfaces that face a mounting board when mounted and top surfaces that face away from the bottom surfaces.

In the coil component according to the present disclosure, the top plate is fixed to the core in a state in which the top plate faces the top surfaces of the first flange portion and the second flange portion and a gap having an average dimension of 20 μm or more and 50 μm or less (i.e., from 20 μm to 50 μm) is provided between the top plate and the top surfaces, and a ratio of a cross-sectional area of the top plate to a cross-sectional area of the winding core portion is 0.478 or more and 0.956 or less (i.e., from 0.478 to 0.956) as viewed along a surface, orthogonal to the axial direction, that passes through a center position of the core in the axial direction.

According to the present disclosure, first, the gap is provided between the top plate and the flange portions, and accordingly, magnetic saturation is suppressed. Here, by the average dimension of the gap being set in the range of 20 μm or more to 50 μm or less (i.e., from 20 μm to 50 μm), the change rate of the inductance value can be kept within ±20% on the basis of the inductance value when the average dimension of the gap is 30 μm.

In addition, according to the present disclosure, by the ratio of the cross-sectional area of the top plate to the cross-sectional area of the winding core portion being set to be 0.478 or more and 0.956 or less (i.e., from 0.478 to 0.956) while the average dimension of the gap is set in the range of 20 μm or more and 50 μm or less (i.e., from 20 μm to 50 μm), the current value at which the inductance value decreases by 30% to be 664 mA or more, and accordingly, good DC superposition characteristics of the coil component can be obtained.

### BRIEF DESCRIPTION OF THE DRAWINGS

FIG. 1 is a front view illustrating the appearance of a coil component according to one embodiment of the present disclosure;

FIG. 2 is a cross-sectional view schematically illustrating an enlarged joint portion between a first flange portion and a top plate of the coil component illustrated in FIG. 1; and

FIGS. 3A to 3C are diagrams for describing the average dimension of a gap between the first flange portion and the top plate.

### DETAILED DESCRIPTION

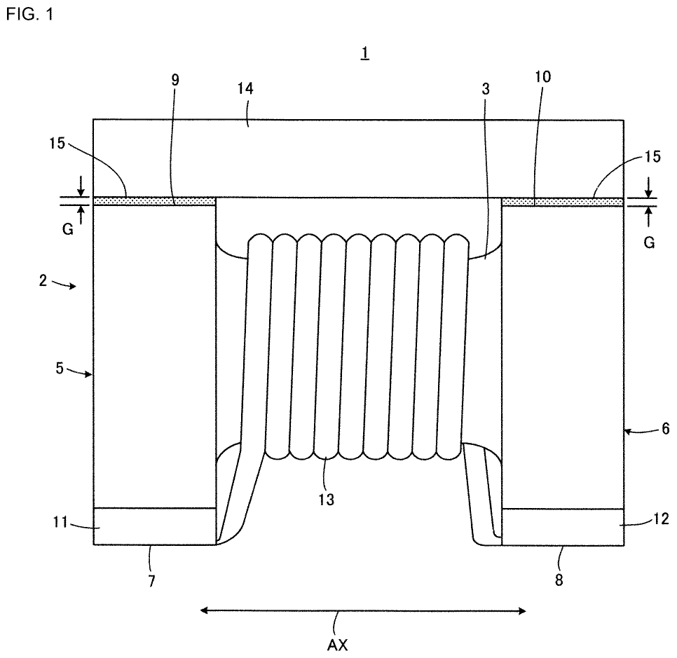

A coil component 1 according to one embodiment of the present disclosure will be described with reference to FIGS. 1 to 3C.

As illustrated in FIG. 1, the coil component 1 includes a core 2 made of a magnetic material, such as a ferrite that is, for example, Ni—Zn based ferrite or a resin containing metal magnetic powder. A material with a relative permeability ranging from, for example, 200 to 1000 may be used as the ferrite. In addition, a resin with a relative permeability ranging from 20 to 60 can be used as the resin containing metal magnetic powder. The core 2 includes a winding core portion 3 that extends in an axial direction AX and first and second flange portions 5 and 6 that are provided at a first end and a second end, respectively, that are opposite to each other in the axial direction AX of the winding core portion 3. The winding core portion 3 has, for example, a rectangular cross-sectional shape but may also have another shape, such as a polygonal shape such as a hexagonal shape, a circular shape, an elliptical shape, or a combination of these shapes.

The first flange portion 5 and the second flange portion 6 have a first bottom surface 7 and a second bottom surface 8 that are directed toward a mounting board (not illustrated) when mounted and a first top surface 9 and a second top surface 10 that face away from the first bottom surface 7 and the second bottom surface 8, respectively.

A first terminal electrode 11 is provided on the bottom surface 7 of the first flange portion 5, and a second terminal electrode 12 is provided on the bottom surface 8 of the second flange portion 6. The terminal electrodes 11 and 12 are formed by performing impregnation or printing with a conductive paste containing conductive metal powder such as Ag powder, baking the conductive paste, and then applying Cu plating, Ni plating, and Sn plating. Alternatively, the terminal electrodes 11 and 12 may be provided by terminal members made from conductive metal plates being attached to the flange portions 5 and 6.

At least one wire 13 is wound around the winding core portion 3. The wire 13 includes a center conductor made of a highly conductive metal, such as copper, silver, or gold, and an insulating coating, made of an electrical insulating resin, such as polyamide-imide, polyurethane, or polyester-imide, that covers the center conductor. The center conductor has a diameter of, for example, 60 μm or more and 160 μm or less (i.e., from 60 μm to 160 μm). One end of the wire 13 is connected to the first terminal electrode 11, and the other end thereof is connected to the second terminal electrode 12. Connection between the terminal electrodes 11 and 12 and the wire 13 are made by, for example, thermal pressure bonding, ultrasonic welding, or laser welding. The number of turns of the wire 13 around the winding core portion 3 is arbitrarily selected according to the required characteristics. The wire 13 may be multi-layered as needed.

The coil component 1 includes the top plate 14 that extends between the first flange portion 5 and the second flange portion 6. The top plate 14 is made of a magnetic material, such as a ferrite that is, for example, Ni—Zn based ferrite or a resin containing metal magnetic powder. It should be noted that, when both the core 2 and the top plate 14 are made of a magnetic material, the top plate 14 forms a closed magnetic circuit together with the core 2.

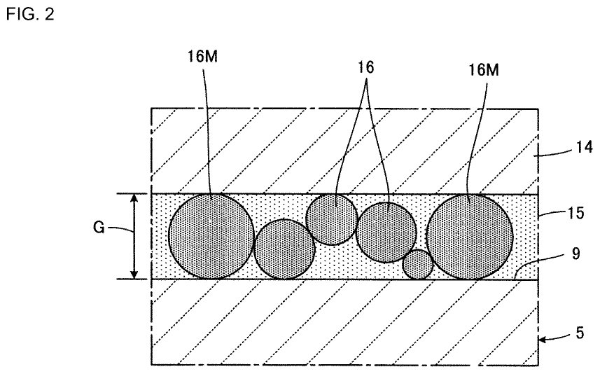

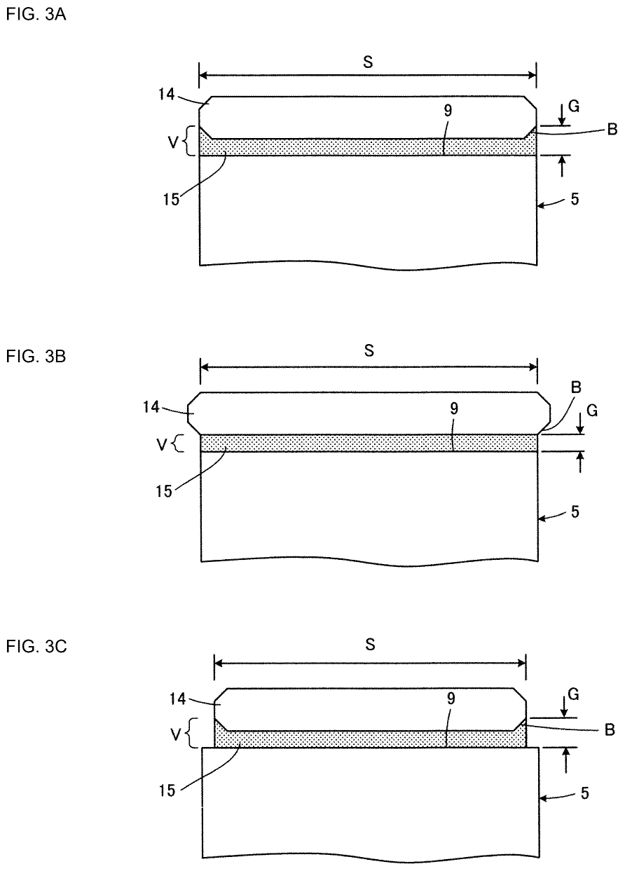

The top plate 14 is fixed to the core 2 in a state in which the top plate 14 faces the top surfaces 9 and 10 of the first flange portion 5 and the second flange portion 6, respectively, and a gap G is provided between the top plate 14 and the top surfaces 9 and 10. A preferred average dimension of the gap G is determined to be 20 μm or more and 50 μm or less (i.e., from 20 μm to 50 μm) in accordance with the simulation results described later. The average dimension of the gap G will be described later with reference to FIGS. 3A to 3C. A non-magnetic material is disposed in the gap G. An adhesive 15 is typically used as the non-magnetic material. The adhesive 15 contains, for example, a thermosetting resin, such as an epoxy resin. As illustrated in FIG. 2, filler particles 16 made of a non-magnetic material, such as silica, are added to the adhesive 15 to improve the thermal shock resistance.

FIG. 2 is a cross-sectional view schematically illustrating an enlarged joint portion between the first flange portion 5 and the top plate 14. It should be noted that the joint portion between the second flange portion 6 and the top plate 14 has a structure that is substantially the same as the structure of the joint portion between the first flange portion 5 and the top plate 14 illustrated in FIG. 2, and accordingly, the description of the joint portion between the first flange portion 5 and the top plate 14 will be referenced.

The filler particles 16 has the function of providing the gap G in addition to the function of improving thermal shock resistance described above. The filler particles 16 have various particle diameters, as illustrated in FIG. 2. Of the filler particles 16 of various particle diameters, at least one filler particle 16M with the maximum particle diameter functions to define the dimensions of the gap G. When the dimension of the gap G is defined by the filler particle 16M (or filler particles 16M) with the maximum particle diameter as described above, the following advantages can be obtained.

When the gap is defined by small projections provided at portions on the top plate that face the flange portions as described in Japanese Unexamined Patent Application Publication No. 2018-107248, the tips of the projections are in direct contact with or come very close to the flange portions, and accordingly, local magnetic saturation is likely to occur at the projections. This causes degradation of DC superposition characteristics. In contrast, when the dimension of the gap G is defined by the filler particle 16M (or filler particles 16M), made of a non-magnetic material, and having the maximum particle diameter and no projections are present as in this embodiment, the degradation of DC superposition characteristics is suppressed.

In the description of the dimension of the gap G above, the term average dimension, which will be described below, has been used. FIGS. 3A to 3C are diagrams for describing the average dimension of the gap G between the first flange portion 5 and the top plate 14. It should be noted that similar description is also applied to the average dimension of the gap G between the second flange portion 6 and the top plate 14.

As illustrated in FIGS. 3A to 3C, a chamfered portion B may be provided on the ridge portion of the top plate 14 to suppress the overflow of the adhesive 15. FIG. 3A illustrates a state in which the outer periphery of the top plate 14 coincides with the outer periphery of the top surface 9 of the flange portion 5, FIG. 3B illustrates a state in which the outer periphery of the top plate 14 is located outside the outer periphery of the top surface 9 of the flange portion 5, and FIG. 3C illustrates a state in which the outer periphery of the top plate 14 is located inside the outer periphery of the top surface 9 of the flange portion 5. In the state in FIG. 3B, the dimension of the gap G is approximately uniform throughout the entire region, but, in the states in FIGS. 3A and 3C, the dimension of the gap G in the peripheral portion is larger than that in the center portion.

In the cases illustrated in FIGS. 3A to 3C, there is a divergence in interpretation regarding how to take the dimension of the gap G: whether to adopt only the dimension of a portion in which the chamfered portion B is absent or to also consider the dimension of the chamfered portion B. Accordingly, in this specification, the dimension of the gap G is defined as follows, and this dimension is referred to as the average dimension.

The area of the portion in which the top surface 9 of the first flange portion 5 overlaps the top plate 14 as viewed in a direction orthogonal to the top surface 9 is defined as S, and the volume between the flange portion 5 and the top plate 14 in this portion is defined as V. In addition, the average dimension of the gap G is defined as V/S, and this is set to 20 μm or more and 50 μm or less (i.e., from 20 μm to 50 μm).

It should be noted that the chamfered portion may also be formed on the core 2 by, for example, barrel-polishing after molding. Even in this case, the average dimension of the gap G can be obtained according to the definition described above.

In the present disclosure, as described above, to reduce the change rate of the inductance value while magnetic saturation is suppressed, the top plate 14 is fixed to the core 2 in a state in which the top plate 14 faces the top surfaces 9 and 10 of the first flange portion 5 and the second flange portion 6 and the gap G having an average dimension of 20 μm or more and 50 μm or less (i.e., from 20 μm to 50 μm) is provided between the top plate 14 and the top surfaces 9 and 10. In addition, the ratio of the cross-sectional area of the top plate 14 to the cross-sectional area of the winding core portion 3 as viewed along a surface that passes through the center position in the axial direction AX of the core 2 and is orthogonal to the axial direction AX is set to be 0.478 or more and 0.956 or less (i.e., from 0.478 to 0.956) to obtain good DC superposition characteristics. These numerical ranges are obtained in accordance with simulation results described below.

In the coil component used in this simulation, the dimension of the core in the length direction (axial direction AX) is set to 2.0 mm, the dimension of the core in the width direction (the direction orthogonal to the sheet in FIG. 1) is set to 1.2 mm, and the dimension of the core in the height direction (the vertical direction in FIG. 1) is set to 1.3 mm. In addition, the dimension of the winding core portion in the width direction is set to 0.74 mm, and the dimension of the winding core portion in the height direction is set to 0.68 mm. In addition, the dimension of the top plate in the axial direction AX is set to 2.0 mm, and the dimension of the top plate in the width direction is set to 1.2 mm. In addition, the core and the top plate are made of ferrite with the same permeability.

In the coil component as described above, by changing the height dimension of the top plate in the height direction (in the vertical direction in FIG. 1) in the range of 0.15 mm to 0.45 mm while changing the average dimension of the gap was changed to 15 μm, 20 μm, 30 μm, 45 μm, 50 μm, and 60 μm, the inductance value and the DC superposition characteristics of the coil component have been obtained by changing the ratio of the cross-sectional area of the top plate to the cross-sectional area of the winding core portion to 0.359, 0.478, 0.598, 0.717, 0.836, 0.956, and 1.074.

Table 1 illustrates the change rate (%) of the inductance value with respect to the inductance value when the average dimension of the gap in the coil component is 30 μm.

As is clear from Table 1, the change rate of the inductance value is suppressed within ±20% in the range in which the average dimension of the gap is 20 μm or more and 50 μm or less (i.e., from 20 μm to 50 μm).

Table 2 illustrates the current value (mA) when the inductance value of the coil component decreases by 30%. The current values illustrated in Table 2 are current values at which the inductance value decreases by 30% from the initial inductance value for which current is not superimposed.

As is clear from Table 2, when the average dimension of the gap ranges from 20 μm or more to 50 μm or less (i.e., from 20 μm to 50 μm) and the cross-sectional area ratio ranges from 0.478 or more to 0.956 or less (i.e., from 0.478 to 0.956), the current value when the inductance value decreases by 30% is 664 mA or more, which indicates good DC superposition characteristics. In addition, when the cross-sectional ratio is set 0.598 or more and 0.956 or less (i.e., from 0.598 to 0.956), the current value when the inductance value decreases by 30% is 758 mA or higher, which indicates better DC superposition characteristics.

In Tables 1 and 2, to clarify preferred ranges, the range in which the average dimension of the gap is 20 μm or more and 50 μm or less (i.e., from 20 μm to 50 μm) and the range in which the cross-sectional ratio is 0.478 or more and 0.956 or less (i.e., from 0.478 to 0.956) are surrounded by a thick dashed line. In addition, the range in which the average dimension of the gap is 20 μm or more and 50 μm or less (i.e., from 20 μm to 50 μm) and the range in which the cross-sectional ratio is 0.598 or more and 0.956 or less (i.e., from 0.598 to 0.956) are surrounded by a thick dash-dot line.

It should be noted that the upper limit of the cross-sectional ratio is 0.956, which is less than 1.000, as described above. That is, the cross-sectional area of the top plate is smaller than that of the winding core portion. This is because the magnetic flux density closer to the top plate is inevitably smaller than the magnetic flux density closer to the winding core portion due to presence of the gap, good DC superposition characteristics can be obtained even when the cross-sectional area of the top plate is smaller than the cross-sectional area of the winding core portion. In other words, even when the cross-sectional area of the top plate is greater than the cross-sectional area of the winding core portion, an advantageous difference regarding DC superposition characteristics cannot be caused.

The coil component according to the present disclosure has been described with reference to the illustrated embodiment, but various other modifications can be made within the scope of the present disclosure.

For example, the gap G may be provided by a sheet made of a non-magnetic material being inserted between the top plate 14 and the top surfaces 9 and 10 of the first flange portion 5 and the second flange portion 6 instead of the adhesive 15, made of a non-magnetic material, that is disposed in the gap G.

In addition, the dimensions of individual portions of the coil component used in the simulation described above are only examples, and the dimensions of individual portions of the coil component can be arbitrarily changed as needed. In the dimensions of the core of the coil component, the dimension in the length direction is 2.0 mm and the dimension in the width direction is 1.2 mm in the simulation. However, for example, the dimension in the length direction may be 3.2 mm and the dimension in the width direction may be 2.5 mm, or the dimension in the length direction may be 4.5 mm and the dimension in the width direction may be 3.2 mm.

In addition, the coil component includes a single coil in the illustrated embodiment, but the coil component to which the present disclosure is applied may also include a common mode choke coil or may also include a transformer or a balun. Accordingly, the number of wires can be changed in accordance with the function of the coil component, and accordingly, the number of terminal electrodes provided on each of the flange portions can also be changed.

In addition, in configuring the coil component according to the present disclosure, the structures of different embodiments described in this specification can be partially replaced or combined.

The present disclosure includes aspects as described below.

<1> A coil component comprising a core, made of a magnetic material, that includes a winding core portion that extends in an axial direction, and a first flange portion and a second flange portion that are provided at a first end and a second end of a winding core portion that extends in an axial direction, the first end and the second end being provided opposite to each other in the axial direction. The coil component further comprises a top plate, made of a magnetic material, that extends between the first flange portion and the second flange portion; and at least one wire wound around the winding core portion. The first flange portion and the second flange portion have bottom surfaces that face a mounting board when mounted and top surfaces that face away from the bottom surfaces. The top plate is fixed to the core in a state in which the top plate faces the top surfaces of the first flange portion and the second flange portion and a gap having an average dimension of 20 μm or more and 50 μm or less (i.e., from 20 μm to 50 μm) is provided between the top plate and the top surfaces. Also, a ratio of a cross-sectional area of the top plate to a cross-sectional area of the winding core portion is 0.478 or more and 0.956 or less (i.e., from 0.478 to 0.956) as viewed along a surface, orthogonal to the axial direction, that passes through a center position of the core in the axial direction.

<2> The coil component according to <1>, wherein the ratio of the cross-sectional area of the top plate to the cross-sectional area of the winding core portion is 0.598 or more and 0.956 or less (i.e., from 0.598 to 0.956).

<3> The coil component according to <1> or <2>, further comprising a non-magnetic material disposed in the gap.

<4> The coil component according to <3>, wherein the non-magnetic material disposed in the gap contains an adhesive.

<5> The coil component according to <4>, wherein the adhesive contains filler particles made of the non-magnetic material for providing the gap.

<6> The coil component according to <5>, wherein the filler particles have various particle diameters, and a dimension of the gap is substantially defined by at least one filler particle of the filler particles having a maximum particle diameter (i.e., the filler particle or filler particles having a maximum particle diameter).

What is claimed is:

1. A coil component comprising:
a core, including a magnetic material, and comprising a winding core portion that extends in an axial direction, and a first flange portion and a second flange portion that are at a first end and a second end, respectively, of the winding core portion, the first end and the second end being opposite to each other in the axial direction;
a top plate, including a magnetic material, that extends between the first flange portion and the second flange portion; and
at least one wire wound around the winding core portion,
wherein
the first flange portion and the second flange portion have bottom surfaces that face a mounting board when mounted and top surfaces that face away from the bottom surfaces,
the top plate is fixed to the core in a state in which the top plate faces the top surfaces of the first flange portion and the second flange portion and a gap having an average dimension of from 20 μm to 50 μm is between the top plate and the top surfaces, and
a ratio of a cross-sectional area of the top plate to a cross-sectional area of the winding core portion is from 0.478 to 0.956 as viewed along a surface, orthogonal to the axial direction, that passes through a center position of the core in the axial direction.

2. The coil component according to claim 1, wherein
the ratio of the cross-sectional area of the top plate to the cross-sectional area of the winding core portion is from 0.598 to 0.956.

3. The coil component according to claim 1, further comprising:
a non-magnetic material in the gap.

4. The coil component according to claim 3, wherein
the non-magnetic material in the gap includes an adhesive.

5. The coil component according to claim 4, wherein
the adhesive includes filler particles including the non-magnetic material for configuring the gap.

6. The coil component according to claim 5, wherein
the filler particles have various particle diameters, and a dimension of the gap is substantially defined by at least one of the filler particles having a maximum particle diameter.
